(19) United States
(12) Patent Application Publication
(10) Pub. No.: US 2004/0059034 A1
(43) Pub. Date: Mar. 25, 2004

(54) Crosslinkable liquid silicone composition comprising a low viscosifying filler based on zirconium, use of same as fire-resistant coating

(76) Inventors: Francois Desne, Philadelphia, PA (US); Alain Pouchelon, Meyzieu (FR)

Correspondence Address: Jean-Louis Seugnet, Rhodia Inc, 259 Prospect Plains Road, CN 7500, Cranbury, NJ, 08512, US

(21) Appl. No.: 10/416,050

(22) PCT Filed: Nov. 9, 2001
(86) PCT No.: PCT/FR01/03494

(30) Foreign Application Priority Data
Nov. 9, 2000 (FR) 00/14404

(51) Int. Cl. C08K 3/10

(52) U.S. Cl. 524/413

(57) ABSTRACT

The invention concerns crosslinkable liquid silicone compositions whereof the inorganic filler can be increased while observing limits of viscosity compatible with coating of woven or nonwoven supports on an industrial scale, and which impart to the supports thermal properties (reducing calorific power and fire-proofing), impermeability and good mechanical characteristics. To achieve this, a mineral compound is used based on zirconium (zirconia or zirconium silicate) as filler slightly thickening ChZr in a crosslinkable liquid silicone composition. The ChZr has a D50 ranging between 3 and 15 μm and is used in a proportion of 100 to 350 parts by weight for 100 parts by weight of the silicone composition without fillers. Said silicone compositions may be of the type crosslinkable by polyaddition or polycondensation. The invention is useful for silicone coating textile tarpaulins for indoor or outdoor structures.

The field of the invention is that of crosslinkable (curable) polyorganosiloxane compositions, that is to say compositions which can be cured to silicone elastomers by polyaddition or polycondensation reactions and for which the main constituents are one or more reactive polyorgano-siloxanes (POSs) and fillers.

Silicone compositions which can be crosslinked by polyaddition comprise at least one POS carrying Si-alkenyl functional groups, preferably Si-Vi functional groups, capable of reacting by hydrosilylation with the Si—H crosslinking functional groups of another POS.

Silicone compositions which can be crosslinked by polycondensation comprise at least one reactive POS carrying condensable or hydrolyzable functional groups, such as, for example, ≡Si-OH, capable of reacting with one another and/or with a crosslinking agent chosen from organosilicon compounds carrying more than two condensable or hydrolyzable functional groups.

More specifically, but without this being limiting, the present invention is targeted at silicon compositions which can be cured under cold conditions (but the curing of which is generally accelerated, e.g. by heat), in particular those of the two-component type (RTV II), which crosslink by polyaddition to produce an elastomer as thin layers. These crosslinked compositions are suitable, inter alia, as coatings, for example for protection or mechanical strengthening of various substrates, in particular made of textile material, such as woven, knitted or nonwoven fibrous supports.

Such coatings of silicone elastomer are generally obtained by coating the substrate and then curing the curing the coated layer, which results from the polyaddition of the unsaturated (alkenyl, e.g. Si-Vi) groups of one POS to hydro groups of another POS.

Silicone elastomer compositions (for example of the RTV II polyaddition type) have found an important outlet in the coating [lacuna] flexible—woven, knitted or nonwoven—material used for the manufacture of coated tarpaulins which are used to produce internal or external architectural structures made of textiles (stands, marquees, roofs for edifices such as stadia, and the like). Silicone elastomers might thus be advantageous substitutes for polymers conventionally used in the coating of tarpaulins for structures involving textiles, namely, for example, poly(vinyl) chloride (PVC) or tetrafluoroethylene (Teflon®).

The functions required for the coating of such tarpaulins are:

ease of coating (viscosity),

strengthening function (mechanical strength, in particular resistance to tearing),

watertightness,

surface appearance and slip,

resistance to external attacks (bad weather, radiation, dust),

longevity,

cost,

degree of ability to transmit sunlight (non-opaqueness),

thermal properties:

flame-retardant nature: ability to prevent the creation or the propagation of flames,

low gross calorific value (CV): the least possible release of heat during combustion: class M0 noninflammability standard (NF-P-92510).

For applications of this type in textile coating of curable liquid silicone compositions, it is clear that one of the determining parameters for the deposition of the layer is the viscosity. In point of fact, the latter is greatly influenced by the nature of the POSs employed (molar mass) but also by the type and the amount of fillers incorporated into the liquid silicone composition.

The filler, generally of inorganic nature, is essential to the crosslinkable-to-elastomer silicone composition for economic reasons and in particular to confer suitable mechanical properties, indeed even thermal properties, on the crosslinked silicone film.

The technical problem always encountered until then is that the incorporation of inorganic fillers, at levels sufficient to meet the technical requirements, necessarily involves a significant increase in the viscosity, which makes it problematic to coat substrates, in particular textile substrates, on industrial machinery operating at high speed (typically of the order of at least 3 to at least 10 m/min).

European patent application EP-0 150 385 discloses a textile tarpaulin coated with a silicone coating comprising an effective amount of a nonabrasive filler for conferring improved resistance to tearing and improved nonflammability properties. The liquid silicone coating composition comprises a POS of the polydimethylsiloxane comprising dimethylvinyl ends type, a POS of the polymethylhydrosiloxane type, a platinum-based catalyst and a filler, preferably based on calcium carbonate or on hydrated alumina. The other nonabrasive fillers which can be used mentioned in this patent are fumed silica, aluminum silicate, potassium titanate, zirconium silicate, carbon black, zinc oxide, titanium dioxide, iron oxide, silica aerogel, precipitated silica, calcium silicate, chromium oxide, cadmium sulfide, talc and the like, magnesium oxide and graphite. In practice, the amount of nonabrasive filler is between 30 and 50 parts by weight per one hundred parts of POS. It is indicated on page 8, line 29, to page 9, line 5, of EP 0 150 385, that precipitated silica or fumed silica results in an undesirable problem of high viscosity and it is proposed to solve this problem by employing an organic solvent, such as hexane. This is naturally a stopgap, insofar as the use of large amounts of organic solvent on an industrial scale is not without causing serious difficulties with regard to health and safety.

Effective thermal properties (low gross calorific value and flame-retardant nature) for the silicone coating of coated textile tarpaulins can be achieved by including large amounts of fillers in the silicone elastomer composition. Thus, the use of large amounts of fillers, such as hydrated aluminas, magnesia or indeed even calcium carbonate, as taught in EP-0 150 385, is particularly advantageous thermally (flame retardancy/lowering of the CV) because of the endothermic effect associated with the dehydration of these fillers when they are heated.

However, this improvement in thermal quality is achieved at the expense of viscosity, which is so high that it makes it difficult, even impossible, on the industrial scale to deposit the silicone composition on the textile substrate.

The inventors of EP-0 150 385 moreover have not misunderstood this since the amount of nonabrasive inorganic fillers which are employed in practice is between 1 [lacuna] at most 50 parts by weight per one hundred parts by weight of POS (40 parts in the examples). At these concentrations, the composition is within acceptable viscosity limits but the mechanical qualities and the fire resistance remain restricted to levels which are sometimes insufficient.

In such a state of knowledge, one of the essential objectives of the invention is to find a means for increasing [lacuna] the inorganic filler of silicone elastomer compositions (in particular textile coating compositions) while remaining within viscosity limits compatible with the deposition on the industrial scale of the silicone layer or layers on the substrate to be coated.

Another essential objective of the invention is to find a filler for a crosslinkable silicone composition which confers good mechanical qualities on the coatings which it is capable of resulting in after crosslinking.

Another essential objective of the invention is to find a filler for a crosslinkable liquid silicone composition—in particular in textile coating—which makes it possible to significantly lower the gross calorific value of the formulations coated using said composition, so as to obtain a coated textile in accordance with a class M1 flame retardancy standard (NF-P-92503) and/or with a type M0 CV standard (NF-P-92510) and/or a type A2 CV standard, this being achieved without bringing about toxic, aggressive or corrosive side effects.

Another essential objective of the invention is to provide a filler for a crosslinkable liquid silicone composition which is compatible with POSs and which does not sully the properties of adhesion of the silicone coating to the substrate.

Another essential objective of the invention is to provide a crosslinkable liquid silicone composition which can be easily applied to a substrate, for example a textile substrate, which adheres well to this substrate and which confers on the latter lasting mechanical and flame retardancy properties.

Another essential objective of the invention is to provide a substrate, preferably a textile substrate, coated on at least one of its faces with a crosslinked silicone coating obtained from a liquid composition which is sufficiently low in viscosity to be able to applied, said coating having to permanently exhibit qualities of adhesion, mechanical qualities and good thermal properties, in particular a low gross calorific value and a flame retardancy nature.

The expression “crosslinkable liquid silicone composition” is understood to mean, within the meaning of the present invention, a crosslinkable silicone composition exhibiting rheological characteristics such that it can be easily employed and deposited on substrates by conventional coating means known to a person skilled in the art (doctor blades, screen printing).

More specifically, this term is intended to denote crosslinkable liquid silicone compositions which exhibit, immediately before coating, a viscosity ηe (mPa·s) such that:

| | |
|---|---|
| | ηe ≦ 200 000, |
| preferably | ηe ≦ 100 000, |
| and more preferably still | ηe ≦ 80 000. |

Having set themselves all these objectives, the inventors have had the credit of selecting, in an inventive and advantageous way, a specific class of inorganic fillers, namely those based on zirconium, so that the objectives targeted above, among others, could be achieved.

The result of this is that the present invention relates first of all to the use of at least one zirconium-based inorganic compound as not very thickening filler (ZrF) in a crosslinkable liquid silicone composition.

The inventors have thus discovered, in an entirely surprising and unexpected way, that the ZrF fillers for a crosslinkable liquid silicone composition are particularly advantageous because of their weakly viscosifying or not very thickening effect. A person skilled in the art could not imagine that this specific class of inorganic fillers could have such a reducing effect on the rheology of silicone liquids (oils).

Within the meaning of the invention, the term “not very thickening” means that the ZrF filler brings about, everything else otherwise being equal, as soon as it is introduced into a medium comprising one or more liquid POSs, a smaller increase in dynamic viscosity in comparison with a reference inorganic filler, namely: ground quartz, the mean particle size of which is generally of the order of 5 to 10 μm.

To quantify somewhat the role of the filler ZrF which it is desired to protect in the context of the present invention, it should be noted that the compound ZrF is much (at least two times) less thickening than quartz, everything else otherwise being equal. This assessment of the reduced viscosifying effect of the ZrF used in accordance with the invention is carried out under the following conditions: suspensions of the fillers to be compared are prepared in a silicone oil and the viscosities thereof are measured (see later the example concerned, which shows that the viscosity is more than 10 times lower with ZrF in comparison with the reference filler).

According to a preferred characteristic of the invention, the zirconium-based inorganic compound is chosen from the group consisting of: zirconia (ZrO₂), zirconium silicates (ZrSiO₄) and their mixtures.

The ground fillers ZrF based on zirconia or on zirconium silicates are minerals of high density.

Preferably, the Zr silicates selected are natural Zr silicates (nondissociated: α form, and/or partially dissociated: β form, and/or completely dissociated: γ form), and/or synthetic Zr silicates.

According to an advantageous characteristic, ZrF comprises Zr silicate assaying at least 50% by weight of ZrO₂.

The compound ZrF can be used alone or in combination with additional conventional (reinforcing or nonreinforcing) fillers. This point will be described in detail below.

Another distinguishing feature of the use according to the invention is due to the proportion of ZrF compounds employed with respect to the crosslinkable liquid composition without fillers (ZrF and optional additional fillers).

Thus, the zirconium-based inorganic compound ZrF is employed in an amount such that the total concentration of inorganic filler (ZrF and optional additional fillers) is at least 100 parts by weight, preferably between 100 and 350 parts by weight and more preferably still between 210 and 300 parts by weight, per 100 parts by weight of the silicone composition, with the exclusion of abovesaid fillers (ZrF and optional additional fillers).

The total concentration of filler which is very particularly well suited lies within the range from 230 to 300 parts by weight with respect to the same reference.

The particle size is another relevant parameter in defining the filler ZrF used according to the invention.

Preferably, the particle size (D₅₀) of the zirconium-based inorganic compound ZrF is such that (μm):

| | |
|---|---|
| | 1 ≦ D₅₀ ≦ 50, |
| preferably | 2 ≦ D₅₀ ≦ 30, |
| and more preferably still | 3 ≦ D₅₀ ≦ 15. |

The particle size parameter D₅₀ is the median size of the particle size distribution. It can be determined on the graph of cumulative particle size distribution obtained by a standard analytical technique, by determining the size corresponding to the cumulative total of 50% of the population of the particles. In concrete terms, a D₅₀ of 10 μm indicates that 50% of the particles have a size of less than 10 μm. The particle size measurements can be carried out by conventional measurements, such as: sedimentation, laser diffraction, optical microscopy coupled to image analysis, and the like.

Advantageously, the specific surface of the filler ZrF used according to the invention is, for example, between 1 and 10 m²/g.

Insofar as it is possible to use, in accordance with the invention, the filler ZrF in large amounts in the liquid silicone composition and that, furthermore, this compound ZrF has a low gross calorific value, it is possible to envisage, in accordance with the invention, the use of the zirconium-based inorganic compound (ZrF) as means for lowering the gross calorific value and/or as flame retardancy means in crosslinkable liquid silicone compositions.

The ability to lower the gross calorific value and the flame-retardant function of the ZrF, which result from its incombustible and refractory nature, makes it possible to confer, on the substrates to which it is applied as coating, a fire resistance which meets the standards required as regards internal and external edifices (for example, M1 standard for flame retardancy and/or M0 standard for CV ≦2 500 joules/g) and/or A2 standard for CV ≦4 200 J/g.

Thus, according to a noteworthy characteristic of the invention, ZrF is used to obtain a silicone composition with a total amount of filler (ZrF and optional additional fillers) representing 100 to 350, preferably 210 to 300, parts by weight per 100 parts by weight of the crosslinking POS composition without fillers (ZrF and optional additional fillers), this composition advantageously having a gross calorific value CV in J/g such that:

| | |
|---|---|
| | CV ≦ 12 000, |
| preferably | CV ≦ 8 000, |
| and more preferably still | CV ≦ 7 000. |

These properties are all the more advantageous since the crosslinking POS composition without fillers concerned initially has a CV of the order of 25 000 J/g.

According to a preferred embodiment of the zirconium-based compound ZrF, the following products are chosen as constituents of the liquid silicone composition (for example for coating), which is of the type of those which can be cured at room temperature (RTV) by polyaddition and which consist of the mixture formed of:

(I) at least one polyorganosiloxane exhibiting, per molecule, at least two C₂-C₆ alkenyl groups bonded to the silicon,

(II) at least one polyorganosiloxane exhibiting, per molecule, at least three hydrogen atoms bonded to the silicon,

(III) a catalytically effective amount of at least one catalyst composed of at least one metal belonging to the platinum group,

(IV) optionally an adhesion promoter,

(V) optionally at least one crosslinking inhibitor,

(VI) and optionally at least one polyorganosiloxane resin comprising 0.1 to 20% by weight of alkenyl groups (preferably vinyl groups) and comprising at least two different units chosen from the following list: M, D, T and Q, at least one of these units being a T or Q unit; this resin preferably corresponding to at least one of the following structures: MQ; MDQ; TD; MDT; it being possible for the alkenyl functional groups to be carried by the M, D and/or T units.

M, D, T and Q units are to be understood, within the meaning of the invention, as being:

M: R₃SiO_{0.5}

D: R₂SiO

T: RSiO_{1.5}

Q: SiO₂

The polyorganosiloxane resin (VI) comprises at least one alkenyl residue in its structure and exhibits a content by weight of alkenyl group(s) of between 0.1 and 20% by weight and preferably between 0.2 and 10% by weight.

These resins (VI) are branched organo-polysiloxane oligomers or polymers which are well known and which are conventionally available. They are provided in the form of solutions, preferably siloxane solutions. They exhibit, in their structure, at least two different units chosen from those of formula M, D, T and Q, at least one of these units being a T or Q unit.

The radicals R are identical or different and are chosen from linear or branched C₁-C₆ alkyl radicals or C₂-C₄ alkenyl, phenyl or 3,3,3-trifluoropropyl radicals. Mention may be made, for example, of: as alkyl radicals R, the methyl, ethyl, isopropyl, tert-butyl and n-hexyl radicals, and, as alkenyl radicals R, the vinyl radicals.

It had been understood that, in the resins (VI) of the abovementioned type, a portion of the radicals R are alkenyl radicals.

Mention may be made, as example of resins which are particularly well suited, of the vinylated MDQ resins having a content by weight of vinyl group of between 0.2 and 10% by weight.

The function of this resin (VI) is to increase the mechanical strength of the silicone elastomer coating and its adhesion, in the context of the coating of the faces of a synthetic fabric (for example made of polyamide). This structural resin (VI) is advantageously present in a concentration of between 10 and 70% by weight with respect to the combined constituents of the composition, preferably between 30 and 60% by weight and more preferably still between 40 and 60% by weight.

The polyorganosiloxane (I) is, by weight, one of the essential constituents of the silicone composition comprising ZrF as filler. Advantageously, it is a product exhibiting units of formula:

$${T}_{a} {Z}_{b} SiO \frac{4 - ( a + b )}{2} \qquad ( I .1 )$$

in which:

T is an alkenyl group, preferably a vinyl or allyl group,

Z is a monovalent hydrocarbonaceous group which does not have an unfavorable effect on the activity of the catalyst and which is preferably chosen from alkyl groups having from 1 to 8 carbon atoms inclusive, optionally substituted by at least one halogen atom, advantageously from the methyl, ethyl, propyl and 3,3,3-trifluoropropyl groups, and as well as from aryl groups and advantageously from the xylyl and tolyl and phenyl radicals,

a is 1 or 2, b is 0, 1 or 2 and a+b is between 1 and 3,

optionally at least a portion of the other units are units of mean formula:

$$Zc SiO \frac{4 - c}{2} \qquad ( I .2 )$$

in which Z has the same meaning as above and c has a value of between 0 and 3,

Z is generally chosen from the methyl, ethyl and phenyl radicals, 60 mol % at least of the Z radicals being methyl radicals.

The polyorganosiloxane (I) can be formed solely of units of formula (I.1) or can additionally comprise units of formula (I.2). Likewise, it can exhibit a linear, branched, cyclic or network structure. Its degree of polymerization is preferably between 50 and 2 000, preferably 100 and 1 000.

Examples of siloxyl units of formula (I.1) are the vinyldimethylsiloxyl unit, the vinylphenyl-methylsiloxyl unit and the vinylsiloxyl unit.

Examples of siloxyl units of formula (I.2) are the SiO_{4/2}, dimethylsiloxyl, methylphenylsiloxyl, diphenylsiloxyl, methylsiloxyl and phenylsiloxyl units.

Examples of polyorganosiloxanes (I) are dimethylpolysiloxanes comprising dimethylvinylsiloxyl ends, methylvinyldimethylpolysiloxyl copolymers comprising trimethylsiloxyl ends, methylvinyldimethyl-polysiloxyl copolymers comprising dimethylvinylsiloxyl ends and cyclic methylvinylpolysiloxyls.

It is advantageous for this polydiorganosiloxane to have a viscosity at least equal to 10 mpa·s, preferably to 500 mPa·s and more preferably still between 5 000 and 200 000 mpa·s. Mention may be made, as example of compound (I), of polydimethylsiloxane comprising dimethylvinyl ends.

All the viscosities concerned within the present account correspond to a dynamic viscosity quantity at 25° C. referred to as “Newtonian”, that is to say the dynamic viscosity which is measured, in a way known per se, at a shear rate gradient which is sufficiently low for the viscosity measured to be independent of the rate gradient.

As regards the polyorganosiloxane (II) of the composition comprising ZrF as filler, it is preferable for it to be of the type of those which comprise siloxyl units of formula:

$${H}_{d} {L}_{e} SiO \frac{4 - ( d + e )}{2} \qquad ( II .1 )$$

in which:

L is a monovalent hydrocarbonaceous group which does not have an unfavorable effect on the activity of the catalyst and which is preferably chosen from alkyl groups having from 1 to 8 carbon atoms inclusive, optionally substituted by at least one halogen atom, advantageously from the methyl, ethyl, propyl and 3,3,3-tetrafluoropropyl groups, and as well as from aryl groups and advantageously from the xylyl and tolyl and phenyl radicals,

d is 1 or 2, e is 0, 1 or 2 and d+e has a value of between 1 and 3,

optionally at least a portion of the other units being units of mean formula:

$${L}_{g} SiO \frac{4 - g}{2} \qquad ( II .2 )$$

in which L has the same meaning as above and g has a value of between 0 and 3.

Preferably, the proportions of (I) and of (II) are such that the molar ratio of the hydrogen atoms bonded to the silicon in (II) to the alkenyl radicals bonded to the silicon in (I) is between 0.4 and 10, preferably between 0.6 and 5.

Mention may be made, as example of polyorganosiloxane (II), of poly(dimethyl)-(methylhydro)siloxane comprising α,ω-dimethylhydrosiloxyl ends.

The polyorganosiloxane (II) can be formed solely of units of formula (II.1) or additionally comprises units of formula (II.2).

The polyorganosiloxane (II) can exhibit a linear, branched, cyclic or network structure. The degree of polymerization is greater than or equal to 2. More generally, it is less than 5 000.

The group L has the same meaning as the group Z above.

Examples of units of formula (II.1) are:

H(CH₃)₂SiO_{1/2}, HCH₃SiO_{2/2}, H(C₆H₅)SiO_{2/2}

The examples of units of formula (II.2) are the same as those those given above for the units of formula (I.2).

Examples of polyorganosiloxane (II) are:

dimethylpolysiloxanes comprising hydrodimethylsiloxyl ends,

poly(dimethyl)(hydromethyl)siloxane copolymers comprising trimethylsiloxyl ends,

poly(dimethyl)(hydromethyl)siloxane copolymers comprising hydrodimethylsiloxyl ends,

poly(hydromethyl)siloxanes comprising trimethylsiloxyl ends,

cyclic poly(hydromethyl)siloxanes.

The dynamic viscosity η_{d} of this polyorganosiloxane (II) and such that:

η_{d} ≧5,

preferably η_{d} ≧10,

and, more preferably still, η_{d} is between 20 and 1 000 mpa·s.

The ratio of the number of hydrogen atoms bonded to the silicon in the polyorganosiloxane (I) to the number of groups comprising alkenyl unsaturation in the polyorganosiloxane (II) is between 0.4 and 10, preferably between 0.6 and 5.

The POSs (I) are preferably linear, while the PoSs (II) are indiscriminately linear, cyclic or network.

The catalysts (III) are also well known. Use is preferably made of platinum and rhodium compounds. Use can in particular be made of the complexes of platinum and of an organic product disclosed in patents U.S. Pat. Nos. 3,159,601, 3,159,602 and 3,220,972 and European patents EP-A-0 057 459, EP-A-0 188 978 and EP-A-0 190 530, or of the complexes of platinum and of vinylated orgaonsiloxanes disclosed in patents U.S. Pat. Nos. 3,419,593, 3,715,334, 3,377,432 and 3,814,730. The catalyst generally preferred is platinum. In this case, the amount by weight of catalyst (III), calculated as weight of platinium metal, is generally between 2 and 400 ppm, preferably between 5 and 200 ppm, based on the total weight of the polyorganosiloxanes (I) and (II).

The silicone composition in which the selected filler ZrF is used can also comprise an adhesion promoter (IV), for example (nonlimiting) of the type of those comprising:

at least one alkoxylated organosilane comprising, per molecule, at least one C₂-C₆ alkenyl group (vinyltrimethoxylsilane or VTMO, or γ-methacryloxypropyltrimethoxysilane or MEMO),

at least one organosilicon compound comprising at least one epoxy radical (3-glycidoxypropyltrimethoxysilane or GLYMO),

and at least one metal chelate and/or one metal alkoxide (butyl titanate).

in a proportion of 0.1 to 10% by weight with respect to the combined constituents of the composition, as disclosed in French patent 2 719 598.

When it is employed, the polyorganosiloxane resin (VI) very preferably corresponds to the following structure: MM(Vi)D(Vi)DQ. Its function is to increase the mechanical strength of the silicone elastomer coating and its adhesion in the context of the coating of the faces of a fabric (for example made of polyamide), for example used to form textile tarpaulins for architectural structures. This stuctural resin is advantageously present in a concentration of between 10 and 90% by weight with respect to the combined constituents of the composition, preferably between 15 and 70% by weight and more preferably still between 20 and 50% by weight.

According to another embodiment of the filler ZrF, the filler-comprising silicone composition can comprise, instead of or in addition to the polyaddition POSs, polycondensation POSs.

Thus, the liquid silicone composition can be a coating composition of the type of those which can be crosslinked by polycondensation and which comprises:

A at least one reactive linear POS carrying, at each chain end, at least two condensable or hydrolyzable groups or a single hydroxyl group,

B optionally at least one nonreactive linear POS not carrying a condensable, hydrolyzable or hydroxyl group,

C optionally water,

D one or more crosslinking agent(s) chosen from silanes and their partial hydrolysis products, said ingredient D being necessary when the reactive POS(s) are α,ω-dihydroxylated POSs and optional when the reactive POS(s) carry, at each chain end, condensable groups (other than OH) or hydrolyzable groups,

E a catalyst for crosslinking or curing by polycondensation,

F optionally one or more additive(s) chosen from pigments, plasticizers, other rheology modifiers, stabilizers and/or adhesion promoters.

Thus, as regards the reactive POSs, they will be oils corresponding to the following formula (1):

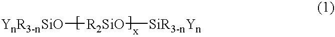

in which:

+R represents identical or different monovalent hydrocarbonaceous radicals and Y represents identical or different hydrolyzable groups or condensable groups (other than OH) or a hydroxyl group,

+n is chosen from 1, 2, and 3, with n=1 when Y is a hydroxyl, and x has a value sufficient to confer, on the oils of formula (1), a dynamic viscosity at 25° C. of between 1 000 and 200 000 mpa·s and preferably between 5 000 and 80 000 mpa·s.

Mention may be made, as examples of radicals R, of alkyl radicals having from 1 to 8 carbon atoms, such as methyl, ethyl, propyl, butyl, hexyl and octyl, or phenyl radicals.

Mention may be made, as examples of substituted radicals R, of the 3,3,3-trifluoropropyl, chlorophenyl and β-cyanoethyl radicals.

Units with the following formulae may be mentioned by way of illustration of those represented by the formula R₂SiO_{2/2}:

(CH₃)₂SiO_{2/2}; CH₃(C₆H₅)SiO_{2/2}; (C₆H₅)₂SiO_{2/2};

CF₃CH₂CH₂(CH₃)SiO_{2/2}; NC—CH₂CH₂(CH₃)SiO_{2/2}.

In the products of formula (1) generally used industrially, at least 80% by number of the radicals R are methyl radicals; the other radicals can generally be phenyl radicals.

Mention may be made, as example of hydrolyzable groups Y, of the amino, acylamino, aminoxy, ketiminoxy, iminoxy, enoxy, alkoxy, alkoxyalkyleneoxy, acyloxy and phosphato groups and, for example, among these, of:

for the amino groups Y: n-butylamino, sec-butylamino and cyclohexylamino groups,

for the N-substituted acylamino groups: the benzoylamino group,

for the aminoxy groups: the dimethylaminoxy, diethylaminoxy, dioctylaminoxy and diphenylaminoxy groups,

for the iminoxy and ketiminoxy groups: those derived from acetophenone oxime, acetone oxime, benzophenone oxime, methyl ethyl ketoxime, diisopropyl ketoxime and chlorocyclohexanone oxime,

for the alkoxy groups Y: the groups having from 1 to 8 carbon atoms, such as the methoxy, propoxy, isopropoxy, butoxy, hexyloxy and octyloxy groups,

for the alkoxyalkyleneoxy groups Y: the methoxyethyleneoxy group,

for the acyloxy groups Y: the groups having from 1 to 8 carbon atoms, such as the formyloxy, acetoxy, propionyloxy and 2-ethylhexanoyloxy groups,

for the phosphato groups Y: those deriving from the dimethyl phosphate, diethyl phosphate and dibutyl phosphate groups.

Mention may be made, as condensable groups Y, of hydrogen atoms and halogen atoms, preferably chlorine.

The reactive POSs preferably used are the α,ω-dihydroxylated diorganopolysiloxanes of formula (1) in which Y═OH, n=1 and x has a value sufficient to confer, on the polymers, a dynamic viscosity at 25° C. of between 1 000 and 200 000 mpa·s and preferably between 5 000 and 80 000 mpa·s.

As regards the nonreactive POSs, they will be oils corresponding to following formula (2):

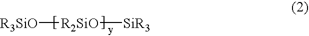

in which the substituents R, which are identical or different, have the same general or specific meanings as those given above for the reactive POSs of formula (1) and the symbol y has a value sufficient to confer, on the polymers, a dynamic viscosity at 25° C. of between 10 and 10 000 mpa·s and preferably between 30 and 2 000 mpa·s.

It should be understood that, in the context of the present invention, it is possible to use, as hydroxylated POSs of formula (1), a mixture composed of several hydroxylated polymers which differ from one another in the value of the viscosity and/or the nature of the substituents bonded to the silicon atoms. Furthermore, it should be pointed out that the hydroxylated polymers of formula (1) can optionally comprise, alongside the units D of formula R₂SiO, units T of formula RSiO_{3/2} and/or SiO₂ units in the proportion of at most 1% (these % expressing the number of T and/or Q units per 100 silicon atoms). The same comments apply to the nonreactive POSs of formula (2).

Mention may more particularly be made, as examples of crosslinking monomeric silane D, of polyacyloxysilanes, polyalkoxysilanes, polyketiminoxysilanes and polyminoxysilanes, and in particular of the following silanes:

CH₃Si(OCOCH₃)₃; C₂H₅Si(OCOCH₃)₃; (CH₂═CH)Si(OCOCH₃)₃;

C₆H₅Si(OCOCH₃)₃; CF₃CH₂CH₂Si(OCOCH₃)₃; NC—CH₂CH₂Si(OCOCH₃)₃;

CH₂ClSi(OCOCH₂CH₃)₃; CH₃Si[ON═C(CH₃)C₂H₅]₂(OCH₂CH₂OCH₃);

CH₃Si[ON═CH—(CH₃)₂]₂(OCH₂CH₂OCH₃); Si(OC₂H₅)₄;

Si(O-n-C₃H₇)₄; Si(O-isoC₃H₇)₄; Si(OC₂H₄OCH₃)₄;

CH₃Si(OCH₃)₃; CH₂═CHSi(OCH₃)₃; CH₃Si(OC₂H₄OCH₃)₃;

ClCH₂Si(OC₂H₅)₃; CH₂═CHSi (OC₂H₄OCH₃)₃.

The partial hydrolysis products, for example from the partial hydrolysis of polyalkoxysilanes, usually known as alkyl polysilicates, are well known products. The most commonly used product is ethyl polysilicate 40® resulting from the partial hydrolysis of Si(OC₂H₅)₄.

The crosslinking agents D preferably used in the case of the preferred use of α,ω-dihydroxylated POSs of formula (1) are the alkyltrialkoxysilanes and the tetraalkoxysilanes of formula (3) RSi(OR)₃; Si(OR)₄, where R represents an alkyl radical having from 1 to 4 carbon atoms, and the partial hydrolysis products of these preferred silanes.

In the case where this composition which can be crosslinked by condensation in the presence of moisture (single-component), the crosslinking or curing catalyst E is a metal catalyst which is preferably chosen from tin monocarboxylates; diorganotin dicarboxylates, a tin(IV) chelate, a hexacoordinated tin(IV) chelate, an organotitanium derivative or a zirconium derivative. The content of catalyst in the single-component compositions is generally between 0.001 and 0.01 parts by weight per 100 parts by weight of the combined reactive POSs.

In the case of a two-component silicone composition which can be crosslinked by polycondensation, the catalyst E used is preferably an organotin derivative as defined above, or a mixture of its entities. The content of catalyst in the two-component compositions is generally between 0.01 and 5 parts by weight per 100 parts by weight of the combined reactive POS(s).

The other additives (F) capable of being employed in the polycondensation silicone compositions comprising ZrF as filler in accordance with the use according to the invention are, with the exception of the adhesion promoter, for example the same as those employed in the polyaddition silicones described above.

According to a specific form of the use in accordance with the invention, the filler ZrF is used in combination with additional fillers preferably chosen from the group consisting of, on the one hand, aluminas, which may or may not be hydrated, magnesias and calcium carbonate (1st category) and, on the other hand, fillers with a structuring nature, such as ultrafine silica, wollastonites, glass beads (preferably hollow glass beads) or polytetrafluoroethylene [PTFE: Teflon®] particles (2nd category), and their mixtures.

The additional fillers of the first category have the improvement of the thermal properties (low gross calorific value and flame-retardant nature) of the coated fabrics. They are present at the level of at least 50 parts by weight per 100 parts by weight of the silicone composition, with the exclusion of the fillers (ZrF and optional additional fillers). In practice, this can represent from 60 to 120 parts by weight per 100 parts by weight of the silicone composition, with the exclusion of the fillers (ZrF and optional additional fillers).

It is preferable for the particle size of these additional bulking fillers to be such that their D₅₀ is between 0.5 and 20 μm.

The additional fillers of the second category have in particular the effect of regulating the rheology of the composition for the purpose of thwarting sedimentation phenomena. In addition to this role, the hollow glass beads also make it possible to reduce the density of the corresponding compositions. The ultrafine silicas of this category exhibit an expanded surface of greater than 100 m²/g; they can be grades with a treated or untreated surface. The hollow glass microbeads which can be used here are characterized by a mean particle size of 10 to 50 μm and a density of between 0.1 and 0.5.

These additional fillers from the second category and with a high specific surface can also be employed as reinforcing filler.

When the filler ZrF according to the invention is used in a silicone composition, the latter is then found to be particularly suitable for coating fibrous or nonfibrous (preferably fibrous) substrates, in particular the substrate made of glass or inorganic fibers, advantageously of synthetic fibers, advantageously of polyamide or of polyester, which are capable of forming coated tarpaulins for the creation of internal or external edifices.

The filler-comprising silicone coating in accordance with the use according to the invention makes it possible to confer, on the tarpaulin, outstanding watertightness properties, an outstanding transparency and outstanding mechanical qualities. Furthermore, in the case where this tarpaulin is composed of a woven or nonwoven fibrous substrate (for example made of glass fibers) which is resistant to fire (low gross calorific value/flame-retardant nature), the filler-comprising silicone coating in accordance with the use according to the invention makes it possible to further improve its thermal properties (lowering the CV), making it possible, for example, for the coated fabric (e.g. glass fabric) to meet the M0 and/or A2 standard.

This whole situation is all the more advantageous since the application of the coating is not problematic to carry out on the industrial scale.

According to another of its subject matters, the present invention relates to a liquid silicone coating composition as defined above, characterized in that the total amount of filler (ZrF and optional additional fillers) represents 100 to 350, preferably 210 to 300, parts by weight per 100 parts by weight of the crosslinking POS composition without fillers (ZrF and optional additional fillers).

The concentration of total filler which is very particularly well suited lies within the range from 230 to 300 parts by weight with respect to the same reference.

In fact, the ZrF filler used in accordance with the invention is particularly advantageous in that it lowers the gross calorific value of silicone coatings. Thus, a silicone composition for which the total filler (ZrF and optional additional fillers) represents 100 to 350, preferably 210 to 300, parts by weight per 100 parts by weight of the crosslinking POS composition without fillers (ZrF and optional additional fillers) advantageously has a gross calorific value CV in J/g such that:

| | |
|---|---|
| | CV ≦ 12 000 |
| preferably | CV ≦ 8 000 |
| and more preferably still | CV ≦ 7 000. |

These properties are all the more advantageous since the filler-free crosslinking POS composition concerned initially has a CV of the order of 25 000 J/g.

According to another of its subject matters, the invention relates to a woven or nonwoven fibrous substrate, characterized in that it is coated on at least one of its faces with the composition as defined above.

The examples which follow describe the preparation of the silicone elastomer composition employed in the context of the use according to the invention, and the application of this composition as coating for glass fabric. These examples will make possible a better understanding of the invention and will make it possible to reveal its advantages and its alternative embodiments. Comparative tests will be used to underline the performance of the ZrF composition.

### EXAMPLES

In these examples, the viscosity is measured using a Brookfield viscometer according to the directions of the AFNOR NFT 76 106 standard of May 82.

Example 1 shows the advantage of the choice of the filler ZrF for the viscosity of the corresponding compositions and example 2 specifies the mechanical and calorific characteristics achieved for the final product.

### Example 1

1.1 Preparation of the Suspensions

The following suspensions are prepared using a laboratory mixer with a central turbine impeller:

A 250 g of the POS (I): polydimethylsiloxane oil with a viscosity of 100 000 mpa·s.

375 g of ground quartz of E 600 grade, supplied by Sifraco®; this filler is characterized by a D₅₀ of the order of 10 μm

B 250 g of the POS (I) as defined in A 375 g of alumina trihydrate of SH 100 grade, supplied by Sochalu®; this filler is characterized by a D₅₀ of the order of 10 μm

C 250 g of the POS (I) as defined in A 375 g of zirconium silicate of Zircon 600 grade, supplied by Atofina®; this filler is characterized by a D₅₀ of the order of 10 μm

1.2 Results

The viscosities measured are expressed in Pa·s

TABLE 1

| Suspension | A | B | C |
|---|---|---|---|
| Viscosity (Pa · s) | 930 | 130 | 32 |

### Example 2

2.1. Preparation of a Primary Paste

The following are introduced into a planetary mixer in the proportions indicated in table 2 below:

the resin (VI) with the structure MM(Vi)D(Vi)DQ comprising approximately 0.6% by weight of vinyl groups,

the ground zircon ZrF (sold by Atofina®),

the α,ω-(dimethylvinylsiloxyl)polydimethylsiloxane oil (I) with a viscosity of 100 000 mpa·s comprising approximately 0.08% by weight of vinyl groups,

the mixture is brought to 120° C. for approximately 2 hours.

TABLE 2

AMOUNTS

| PRODUCTS EMPLOYED | in parts | by weight (g) |
|---|---|---|
| Resin (VI) | 75 | 300 |
| POS oil (I) | 16 | 64 |
| Ground zircon ZrF | 250 | 1 000 |

2.2. Preparation of the Part P1 of the Two-component Formulation

The following ingredients are mixed in a reactor at ambient temperature in the proportions indicated in table 3 below:

the above paste,

the α,ω-(dimethylhydrosiloxyl)-poly(dimethylsiloxy)methylhydrosiloxane oil (II) with a viscosity of 300 mPa·s and comprising 0.17% by weight of H groups,

ethynylcyclohexanol,

the adhesion promoters (IV).

TABLE 3

AMOUNTS

| PRODUCTS EMPLOYED | in parts | by weight (g) |
|---|---|---|
| Primary paste | 341 | 519.7 |
| POS oil (II) | 7 | 10.65 |
| VTMO (IV) | 1 | 1.55 |
| GLYMO (IV) | 1 | 1.55 |
| Ethynylcyclohexanol | 0.025 | 0.038 |

2.3. Preparation of the Part P2 of the Two-component Formulation

The following are mixed in a reactor at ambient temperature in the proportions shown in table 4 below:

the above paste,

the α,ω-(dimethylvinylsiloxyl)-polydimethylsiloxe oil (I) with a viscosity of 100 000 mpa·s, comprising approximately 0.08% by weight of vinyl groups,

Pt metal, crosslinking catalyst (III) introduced in the form of an organometallic complex,

the remainder of the adhesion promoters (IV).

TABLE 4

AMOUNTS

| PRODUCTS EMPLOYED | in parts | by weight (g) |
|---|---|---|
| Primary paste | 341 | 519.7 |
| POS oil (I) | 5 | 7.6 |
| Butyl orthotitanate (TBOT) | 4 | 6.1 |
| Catalyst (comprising 10% of | 0.0215 | 0.33 |
| Pt) | | |

2.4. Preparation of the Two-component Formulation

The two-component formulation is obtained by mixing, at ambient temperature, 100 parts by weight of the part P1 and 10 parts by weight of the part P2.

2.5. Application Procedure

Standard elastomeric test specimens of the two-component formulation, plaques with a thickness of 2 mm and slugs with a thickness of 6 mm, are prepared for the measurements; their crosslinking takes place therein in 10 min at 150° C.

The same mixture is coated using doctor blades on a glass fabric with a weight per unit area of 210 g/m² in a proportion of 70 g/m² per face and is crosslinked at 150° C. for 2 minutes in a ventilated oven after each coating.

2.6. Results

The experimental data of the tests carried out are presented in Table 5 below.

TABLE 5

| | | |
|---|---|---|
| Vicosity part A | 36 | Pa · s |
| Viscosity part B | 65 | Pa · s |
| Viscosity part A + B | 44 | Pa · s |
| Shore A hardness | 78 | |
| Failure | 6.8 | MPa 55% |
| Tear | 10.9 | N/mm |

Method of Measuring the Gross Calorific Value:

Device:

IKA-C 4000A adiabatic calorimeter

Parameters of the adiabatic calorimeter:

30 bar O₂ ±1 bar

1.8 1 of water 25° C. ±0.1° C.

Ignition device (cotton strand 50 J and metal wire 30 J).

The measurement is carried out on 1 g of ground crosslinked elastomer mixed with 1 g of ground benzoic acid. Once mixed, the two products are placed in a crucible, which is connected to an ignition device using the cotton strand and the metal wire mentioned above. This crucible is subsequently placed in a bomb calorimeter which is filled with oxygen to 30 bar.

The bomb calorimeter is placed in the adiabatic calorimeter. It is placed in the chamber so that the heat which it gives off can heat the 1.8 liters of water at constant temperature.

After ignition, the sample is consumed. It gives off a certain amount of heat, a function of its gross calorific value, which heats the 1.8 liters of water at a temperature of 25° C. ±0.1° C. The heating of the water (that is to say, the temperature delta of the 1.8 liters of water which are heated under the action of the heat given off by the sample) makes it possible to determine, by a calculation which will not be described in detail as it is known to a person skilled in the art, the gross calorific value of the product tested.

Calibration:

It is carried out with pellets of benzoic acid with the gross calorific value of 26 500 J/g. This calibration is carried out every three months.

The repeatability of the test is monitored at 660 cal/g ±10 cal/g.

Results of CV Measurement:

Gross calorific value of the crosslinked elastomer: 5 835 joules/g. This result is to be compared with the values well known to a person skilled in the art, of the order of 25 000 J/g, for a filler-free silicone composition.

Gross calorific value of the coated fabric: 2 350 joules/g (M0 standard).

1. Use of at least one zirconium-based inorganic compound as not very thickening filler (ZrF) in a crosslinkable liquid silicone composition.

2. The use as claimed in claim 1, characterized in that the zirconium-based inorganic compound is chosen from the group consisting of:
zirconia (ZrO₂), zirconium silicates (ZrSiO₄) and their mixtures.

3. The use as claimed in claim 1 or 2, characterized in that the compound ZrF is at least 2 times less thickening than quartz, everything else otherwise being equal.

4. The use as claimed in any one of claims 1 to 3, characterized in that the zirconium-based inorganic compound ZrF is employed in an amount such that the total concentration of inorganic filler (ZrF+optional additional fillers) is at least 100 parts by weight, preferably between 100 and 350 parts by weight and more preferably still between 210 and 300 parts by weight, per 100 parts by weight of the crosslinkable silicone composition, with the exclusion of abovesaid fillers (ZrF+optional additional fillers).

5. The use as claimed in any one of claims 1 to 4, characterized in that the particle size (D₅₀) of the zirconium-based inorganic compound ZrF is such that (μm):

| | |
|---|---|
| | 1 ≦ D₅₀ ≦ 50, |
| preferably | 2 ≦ D₅₀ ≦ 30, |
| and more preferably still | 3 ≦ D₅₀ ≦ 15. |

6. The use as claimed in any one of claims 1 to 5, characterized in that the zirconium-based inorganic compound ZrF is also made use of as means for lowering the gross calorific value and/or as flame-retardancy means.

7. The use as claimed in any one of claims 1 to 6, characterized in that the liquid silicone composition is a coating composition of the type of those which can be cured at room temperature (RTV) by polyaddition and which comprises the mixture formed of:
(I) at least one polyorganosiloxane exhibiting, per molecule, at least two C₂-C₆ alkenyl groups bonded to the silicon,
(II) at least one polyorganosiloxane exhibiting, per molecule, at least three hydrogen atoms bonded to the silicon,
(III) a catalytically effective amount of at least one catalyst composed of at least one metal belonging to the platinum group,
(IV) optionally an adhesion promoter,
(V) optionally at least one crosslinking inhibitor,
(VI) and optionally at least one polyorganosiloxane resin comprising 0.1 to 20% by weight of alkenyl groups (preferably vinyl groups) and comprising at least two different units chosen from the following list: M, D, T and Q, at least one of these units being a T or Q unit.

8. The use as claimed in any one of claims 1 to 7, characterized:
in that the polyorganosiloxane (I) of the filler-comprising composition exhibits units of formula:
$${T}_{a} {Z}_{b} SiO \frac{4 - ( a + b )}{2} \qquad ( I .1 )$$
in which:
T is an alkenyl group, preferably a vinyl or allyl group,
Z is a monovalent hydrocarbonaceous group which does not have an unfavorable effect on the activity of the catalyst and which is preferably chosen from alkyl groups having from 1 to 8 carbon atoms inclusive, optionally substituted by at least one halogen atom, advantageously from the methyl, ethyl, propyl and 3,3,3-trifluoropropyl groups, and as well as from aryl groups and advantageously from the xylyl and tolyl and phenyl radicals,
a is 1 or 2, b is 0, 1 or 2 and a+b is between 1 and 3,
optionally at least a portion of the other units are units of mean formula:
$$Zc SiO \frac{4 - c}{2} \qquad ( I .2 )$$
in which Z has the same meaning as above and c has a value of between 0 and 3;
in that the polyorganosiloxane (II) of the filler-comprising composition comprises siloxyl units of formula:
$${H}_{d} {L}_{e} SiO \frac{4 - ( d + e )}{2} \qquad ( II .1 )$$
in which:
L is a monovalent hydrocarbonaceous group which does not have an unfavorable effect on the activity of the catalyst and which is preferably chosen from alkyl groups having from 1 to 8 carbon atoms inclusive, optionally substituted by at least one halogen atom, advantageously from the methyl, ethyl, propyl and 3,3,3-tetrafluoropropyl groups, and as well as from aryl groups and advantageously from the xylyl and tolyl and phenyl radicals,
d is 1 or 2, e is 0, 1 or 2 and d+e has a value of between 1 and 3,
optionally at least a portion of the other units being units of mean formula:
$${L}_{g} SiO \frac{4 - g}{2} \qquad ( II .2 )$$
in which L has the same meaning as above and g has a value of between 0 and 3;
and in that the proportions of (I) and of (II) are such that the molar ratio of the hydrogen atoms bonded to the silicon in (II) to the alkenyl radicals bonded to the silicon in (I) is between 0.4 and 10, preferably between 0.6 and 5.

9. The use as claimed in any one of claims 1 to 6, characterized in that the liquid silicone composition is a coating composition of the type of those which can be crosslinked by polycondensation and which comprises:
A at least one reactive linear POS carrying, at each chain end, at least two condensable or hydrolyzable groups or a single hydroxyl group,
B optionally at least one nonreactive linear POS not carrying a condensable, hydrolyzable or hydroxyl group,
C optionally water,
D one or more crosslinking agent(s) chosen from silanes and their partial hydrolysis products, said ingredient D being necessary when the reactive POS(s) are α,ω-dihydroxylated POSs and optional when the reactive POS(s) carry, at each chain end, condensable groups (other than OH) or hydrolyzable groups,
E a catalyst for crosslinking or curing by polycondensation,
F optionally one or more additive(s) chosen from pigments, plasticizers, other rheology modifiers, stabilizers and/or adhesion promoters.

10. The use as claimed in any one of claims 1 to 9, characterized in that the filler ZrF is used in combination with additional fillers preferably chosen from the group consisting of, on the one hand, aluminas, which may or may not be hydrated, magnesias and calcium carbonate and, on the other hand, ultrafine silica, wollastonites, glass beads and polytetrafluoroethylene [PTFE: TEFLON®] particles, and their mixtures.

11. The use as claimed in any one of claims 1 to 10, characterized in that the liquid silicone composition is a composition intended for coating fibrous or nonfibrous (preferably fibrous) substrates, in particular substrates made of inorganic fibers, advantageously glass fibers, or synthetic fibers, advantageously polyester or polyamide fibers.

12. A crosslinkable liquid silicone coating composition, characterized in that it is intended for coating fibrous or nonfibrous (preferably fibrous) substrates, in particular substrates made of inorganic fibers, advantageously glass fibers, or synthetic fibers, advantageously polyester or polyamide fibers, in that it comprises at least one zirconium-based inorganic compound as not very thickening filler (ZrF) and in that its total amount of filler (ZrF and optional additional fillers) represents 100 to 350, preferably 210 to 300, parts by weight per 100 parts by weight of the crosslinking POS composition without fillers (ZrF and optional additional fillers).

13. The liquid silicone coating composition as claimed in claim 12, characterized in that it has a gross calorific value CV in J/g such that:

| | |
|---|---|
| | CV ≦ 12 000 |
| preferably | CV ≦ 8 000 |
| and more preferably still | CV ≦ 7 000. |

14. A woven or nonwoven fibrous substrate, characterized in that it is coated on at least one of its faces with the composition as claimed in claim 12 or 13.
